(19) United States
(12) Patent Application Publication
(10) Pub. No.: US 2026/0255085 A1
(43) Pub. Date: Aug. 27, 2026

(54) IMAGING ELEMENT AND IMAGING DEVICE

(71) Applicant: NIKON CORPORATION, Tokyo (JP)

(72) Inventors: Wataru FUNAMIZU, Yokohama-shi (JP); Osamu SARUWATARI, Yokohama-shi (JP); Shutaro KATO, Kawasaki-shi (JP)

(73) Assignee: NIKON CORPORATION, Tokyo (JP)

(21) Appl. No.: 18/707,209

(22) PCT Filed: Nov. 2, 2022
(86) PCT No.: PCT/JP2022/041075

§ 371 Date: May 4, 2026

(30) Foreign Application Priority Data
Nov. 5, 2021 (JP) 2021-181339

(51) Int. Cl. H04N 25/78; H04N 25/771; H04N 25/79

(52) U.S. Cl. CPC H04N 25/78; H04N 25/771; H04N 25/79

(57) ABSTRACT

An imaging element comprising a plurality of pixels; a plurality of conversion units that convert an analog signal into a digital signal and store it temporarily; a first output line that is connected to a first conversion unit of the plurality of conversion units and to which a signal converted in the first conversion unit into the digital signal is output; a second output line that is connected to a second conversion unit of the plurality of conversion units and to which a signal converted in the second conversion unit into the digital signal is output; and a readout circuit that reads out the digital signals temporarily stored in a plurality of first conversion units and the digital signals temporarily stored in a plurality of second conversion units at different timings from each other.

### BACKGROUND

### 1. Technical Field

The present invention relates to an imaging element and an imaging device.

### 2. Related Art

An imaging element is known which can process signals, in a parallel manner, each output from a plurality of pixels (for example, Patent Document 1). Conventionally, there has been a problem of an increase in consumption current due to parallel processing of signals from pixels.

### PRIOR ART DOCUMENT

### Patent Document

Patent Document 1: International publication number WO2013/129202

### GENERAL DISCLOSURE

In a first aspect of the present invention, an imaging element comprises: a first substrate that includes a pixel unit in which a plurality of pixels are arranged in line in a row direction, each of the plurality of pixels includes at least a photoelectric conversion unit which converts light into an electric charge; and a second substrate that includes a processing circuit unit in which a first pixel circuit including at least a first pixel memory that stores a first pixel signal from a first pixel in the plurality of pixels, and a second pixel circuit including at least a second pixel memory that stores a second pixel signal from a second pixel in the plurality of pixels, are arranged, and a readout control circuit to read out the first pixel signal stored in the first pixel memory and the second pixel signal stored in the second pixel memory at different timings from each other. The second pixel may be arranged next to the first pixel in line in the row direction. The second pixel circuit may be arranged next to the first pixel circuit in line in the row direction. The imaging element may comprise: a first selection line to which a first control signal is output to read out the first pixel signal stored in the first pixel memory; and a second selection line to which a second control signal is output to read out the second pixel signal stored in the second pixel memory. The readout control circuit may perform control so that a timing of outputting the first control signal to the first selection line and a timing of outputting the second control signal to the second selection line are different from each other. The readout control circuit may perform control so that a timing of starting output of the first control signal and a timing of starting output of the second control signal are different from each other. The readout control circuit may start output of the second control signal after starting output of the first control signal. The readout control circuit may start output of the second control signal after finishing output of the first control signal. The imaging element may comprise: a first output line to which the first pixel signal read out from the first pixel memory is output; and a second output line to which the second pixel signal read out from the second pixel memory is output. The readout control circuit may perform control so that a timing of reading out the first pixel signal from the first pixel memory to the first output line and a timing of reading out the second pixel signal from the second pixel memory to the second output line are different from each other. The readout control circuit may perform control so that a timing of starting readout of the first pixel signal and a timing of starting readout of the second pixel signal are different from each other. The readout control circuit may start readout of the second pixel signal after starting readout of the first pixel signal. The readout control circuit may start readout of the second pixel signal after finishing readout of the first pixel signal. The first pixel circuit may include a first comparator that is used to convert the first pixel signal from the first pixel into a digital signal. The second pixel circuit may include a second comparator that is used to convert the second pixel signal from the second pixel into a digital signal. The first pixel memory may store the first pixel signal converted into the digital signal using the first comparator. The second pixel memory may store the second pixel signal converted into the digital signal using the second comparator. Each of the first pixel memory and the second pixel memory may be constituted by SRAM. The first substrate and the second substrate may be arranged so that at least part of the pixel unit and at least part of the processing circuit unit face each other. The first substrate and the second substrate may be arranged so that at least part of the first pixel and at least part of the first pixel circuit face each other. The first substrate and the second substrate may be arranged so at least part of the second pixel and at least part of the second pixel circuit face each other. The second substrate may include a pixel control circuit that controls each of the first pixel and the second pixel. The pixel control circuit may control an exposure time of the first pixel and an exposure time of the second pixel. The pixel control circuit may control readout of the first pixel signal from the first pixel and readout of the second pixel signal from the second pixel. The processing circuit unit may be arranged between the readout control circuit and the pixel control circuit in the row direction. The second substrate may include an image processing unit that performs image processing on the first pixel signal stored in the first pixel memory and the second pixel signal stored in the second pixel memory. The imaging element may comprise a third substrate that includes an image processing unit that performs image processing on the first pixel signal stored in the first pixel memory and the second pixel signal stored in the second pixel memory.

In a second aspect of the present invention, an imaging device comprises any one of the imaging elements described above. The imaging device may comprise a control unit that is connected to the imaging element. The control unit may generate image data based on the first pixel signal and the second pixel signal.

The summary clause does not necessarily describe all necessary features of the embodiments of the present invention. In addition, the invention may also be a sub-combination of the features described above.

### BRIEF DESCRIPTION OF THE DRAWINGS

FIG. 1 shows an overview of an imaging element 400 according to the present embodiment.

FIG. 2 shows an example of a flat layout of a first substrate 100.

FIG. 3 shows an example of a flat layout of a second substrate 200.

FIG. 4 shows an example of a circuit configuration of a pixel 112 and a pixel circuit 212.

FIG. 5 schematically illustrates a circuit for reading out data in a pixel memory 220 to an image processing/outputting unit 280.

FIG. 6 schematically illustrates, in more detail, a circuit for readout from the pixel memory 220 in a processing circuit unit 210.

FIG. 7 is an example of a timing chart indicating a readout operation from the pixel memory 220 of FIG. 6.

FIG. 8 is an example of a timing chart indicating a readout operation from the pixel memory 220 of FIG. 6.

FIG. 9 schematically illustrates, in detail, a circuit for readout from the pixel memory 220 in another processing circuit unit 310.

FIG. 10 is an example of a timing chart indicating a readout operation from the pixel memory 220 of FIG. 9.

FIG. 11 is an example of a timing chart indicating a readout operation from the pixel memory 220 of FIG. 9.

FIG. 12 schematically illustrates, in detail, a circuit for readout from the pixel memory 220 in still another processing circuit unit 410.

FIG. 13 is an example of a timing chart indicating a readout operation from the pixel memory 220 of FIG. 12.

FIG. 14 is an example of a timing chart indicating a readout operation from the pixel memory 220 of FIG. 12.

FIG. 15 is a block diagram showing a configuration example of an imaging device 500 according to an embodiment.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

In the present specification, the X-axis and the Y-axis are orthogonal to each other, and the Z-axis is orthogonal to the XY plane. The XYZ axes constitute a right-handed system. A direction parallel to the Z-axis may be referred to as a stacking direction of the imaging element 400. In the present specification, the terms “upper” and “lower” are not limited to the upper and lower direction in the direction of gravity. These terms just refer to relative directions in the Z-axis direction. Note that, in the present specification, an array in the X-axis direction is described as a “row” and an array in the Y-axis direction is described as a “column”, but the row-column direction is not limited thereto. In addition, the z-axis direction is defined as an optical axis direction in which a light is incident from a subject.

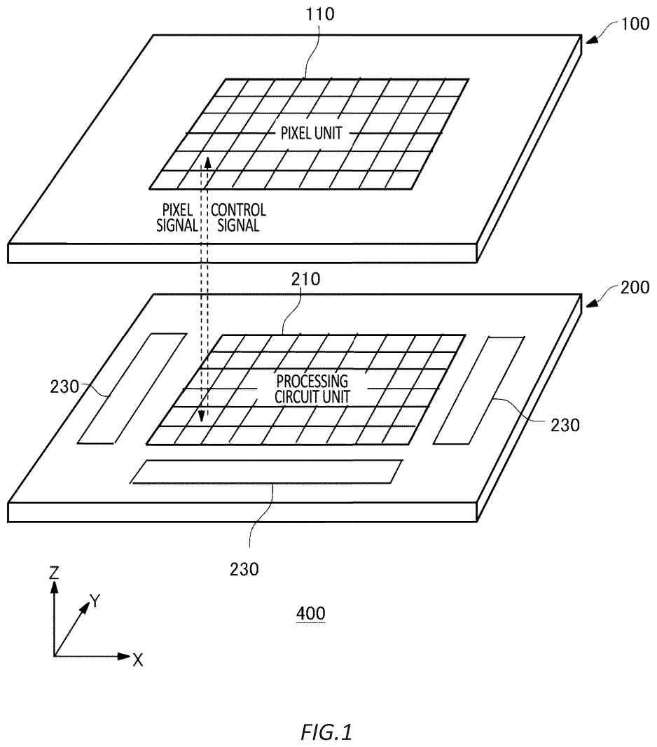

FIG. 1 shows an overview of an imaging element 400 according to the present embodiment. The imaging element 400 is configured to capture an image of a subject. The imaging element 400 is configured to generate image data of the captured subject. The imaging element 400 includes a first substrate 100 and a second substrate 200. As illustrated in FIG. 1, the first substrate 100 is stacked above the second substrate 200.

The first substrate 100 includes a pixel unit 110. The pixel unit 110 outputs a pixel signal based on an incident light. Note that, the first substrate 100 may be referred to as a pixel chip in some cases.

The second substrate 200 includes a processing circuit unit 210 and peripheral circuit unit 230. Note that, the second substrate 200 may be referred to as a signal processing chip in some cases.

A pixel signal output from the first substrate 100 is input to the processing circuit unit 210. The processing circuit unit 210 processes the input pixel signal. For example, the processing circuit unit 210 converts an analog signal into a digital signal. Specifically, the processing circuit unit 210 converts an input pixel signal into a digital signal. The processing circuit unit 210 may perform other kinds of signal processing.

The processing circuit unit 210 of the present example is arranged in a position, of the second substrate 200, opposite to the pixel unit 110. That is, the processing circuit unit 210 is disposed so as to overlap at least partially with the pixel unit 110 in an optical axis direction. The processing circuit unit 210 may output, to the pixel unit 110, a control signal to control the driving of the pixel unit 110.

The peripheral circuit unit 230 controls the driving of the processing circuit unit 210. The peripheral circuit unit 230 is arranged in the periphery of the processing circuit unit 210 in the second substrate 200. In addition, the peripheral circuit unit 230 may be electrically connected to the first substrate 100 to control the driving of the pixel unit 110.

In addition to the first substrate 100 and the second substrate 200, the imaging element 400 may include a third substrate stacked on the second substrate 200. For example, the third substrate is a memory chip to perform image processing according to a signal output by the second substrate 200 for storage. In addition, a structure of the imaging element 400 may be of a back-side illumination type or a front-side illumination type. In the following descriptions, the back-side illumination type will be exemplified.

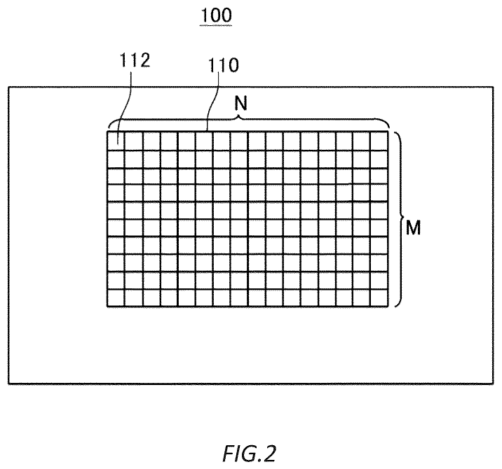

FIG. 2 shows an example of a flat layout of the first substrate 100. The pixel unit 110 is disposed near the center of the first substrate 100 on its surface.

The pixel unit 110 includes a plurality of pixels 112 arranged in line along a row direction and a column direction. The pixel unit 110 of the present example includes M×N pixels 112 (M and N are natural numbers). The illustrated M and N are different from each other in the present example, although they may be the same.

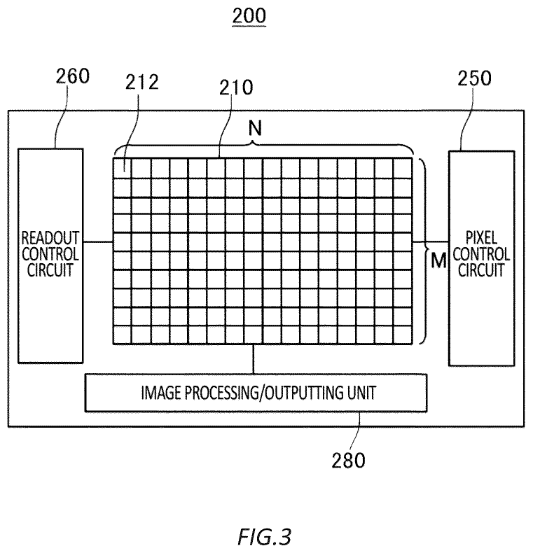

FIG. 3 shows an example of a flat layout of the second substrate 200. The processing circuit unit 210 is disposed near the center of the second substrate 200 on its surface.

The processing circuit unit 210 includes a plurality of pixel circuits 212 arranged in line along the row direction and the column direction. The processing circuit unit 210 of the present example includes M×N pixel circuits 212.

In the present embodiment, a pixel circuit 212 and a pixel 112 are disposed in a position overlapped with each other when viewed in the optical axis direction. In this case, areas of the pixel circuit 212 and the pixel 112, including margins between adjacent blocks, may be substantially the same.

The pixel circuit 212 controls the driving of the pixel 112 to which it is electrically connected. The pixel circuit 212 and pixel 112 being electrically connected may be referred to as “corresponding” to each other in some cases.

In the present embodiment, the pixel circuit 212 and the pixel 112 disposed in a position overlapped with each other are connected. However, instead of the pixel circuit 212 and the pixel 112 disposed in the overlapped position being connected, the pixel circuit 212 and the pixel 112 that are disposed in positions not being overlapped with each other may be connected.

A pixel control circuit 250, a readout control circuit 260 and an image processing/outputting unit 280 are disposed in the periphery of the processing circuit unit 210, each being an example of the peripheral circuit unit 230. The pixel control circuit 250 controls the pixel 112 and the pixel circuit 212. For example, the pixel control circuit 250 supplies a control signal for the pixel circuit 212 to perform A/D conversion of a signal from the pixel 112. In addition, the pixel control circuit 250 controls an exposure time of the pixel 112, for example. The readout control circuit 260 controls readout of a pixel signal stored in the pixel circuit 212 to output the pixel signal to the image processing/outputting unit 280.

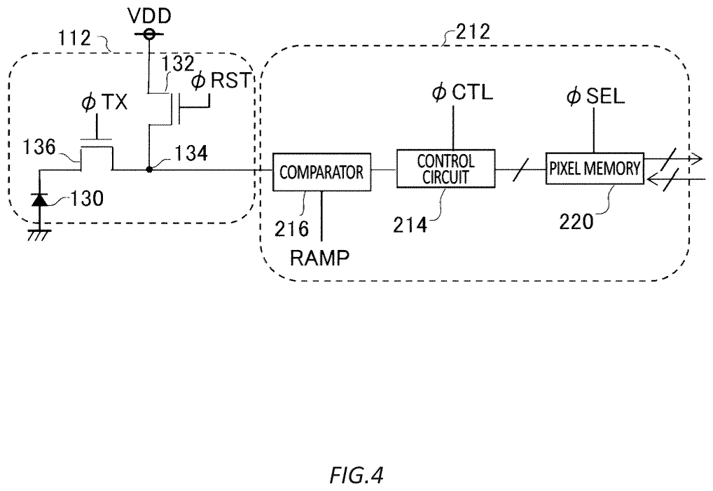

FIG. 4 shows an example of a circuit configuration of the pixel 112 and the pixel circuit 212. The pixel 112 includes an photoelectric conversion unit 130, a reset unit 132, an accumulation unit 134, and a transfer unit 136.

The photoelectric conversion unit 130 includes a photoelectric conversion function to convert light into electric charges and an accumulation function to accumulate the electric charges converted from the light. The photoelectric conversion unit 130 is, for example, a photo diode.

The accumulation unit 134 converts the electric charges generated by the photoelectric conversion unit 130 into voltage according to an amount of the electric charges. The accumulation unit 134 is an example of a floating diffusion (FD).

The reset unit 132 discharges, based on a control signal φRST, the electric charges in the accumulation unit 134 to a power supply wiring line through which a predetermined power supply voltage VDD is supplied. A gate terminal of the reset unit 132 is connected to the pixel control circuit 250.

The transfer unit 136 transfers, based on a control signal φTX, the electric charges accumulated in the photoelectric conversion unit 130 to the accumulation unit 134. In addition, the transfer unit 136 resets, based on the control signal φTX, the electric charges accumulated in the photoelectric conversion unit 130. For example, the transfer unit 136 resets the electric charges accumulated in the photoelectric conversion unit 130 to zero by simultaneously supplying the control signal φTX and the control signal φRST. The transfer unit 136 is an example of a transfer gate for transferring the electric charges of the photoelectric conversion unit 130. In other words, the transfer unit 136 as a gate, the photoelectric conversion unit 130 as a source, and the accumulation unit 134 as a drain constitute a so-called transfer transistor.

The pixel circuit 212 includes a comparator 216, a control circuit 214, and a pixel memory 220. The comparator 216 compares a voltage of the accumulation unit 134 and a reference voltage RAMP supplied by the pixel control circuit 250, and outputs the comparison result to the control circuit 214. For example, the comparator 216 is constituted by a differential pair. In addition, a source follower circuit may be disposed between the comparator 216 and the accumulation unit 134, for example. The control circuit 214 controls the pixel memory 220 based on a signal from the comparator 216 and a signal of φCTL.

The pixel memory 220 stores the pixel signal converted into a digital signal. For example, the pixel memory 220 receives a count signal supplied by the pixel control circuit 250, and when the control signal output by the control circuit 214 is inverted, the pixel memory 220 stores a value of the count signal at that time. Moreover, the pixel memory 220 outputs, based on a selection signal φSEL, the pixel signal stored therein. An example of the pixel memory 220 is SRAM.

An exemplary operation of one frame of the pixel 112 and the pixel circuit 212 will be described. First, at the start of accumulation in one frame, the pixel control circuit 250 resets the electric charges accumulated in the photoelectric conversion unit 130 by simultaneously supplying the control signal φTX and the control signal φRST. Then, during the readout at the end of one frame, the pixel control circuit 250 resets the voltage of the accumulation unit 134 to a predetermined voltage by supplying the control signal φRST. Subsequently, the pixel control circuit 250 causes the pixel memory 220 to store a value corresponding to the reset voltage of the accumulation unit 134 (DARK conversion), by controlling the control signal φCTL, the reference voltage RAMP, and the count signal to be supplied to the pixel memory 220. Then, the readout control circuit 260 reads out data of the DARK conversion result stored in the pixel memory 220 to the image processing/outputting unit 280 by controlling the selection signal φSEL. Further description of the data readout from the pixel memory 220 will be provided below. Moreover, the pixel control circuit 250 transfers the electric charges accumulated in the photoelectric conversion unit 130 to the accumulation unit 134 by supplying the control signal φTX. Subsequently, the pixel control circuit 250 causes the pixel memory 220 to store a value corresponding to the voltage of the accumulation unit 134 after the electric charge transfer (SIG conversion), by controlling the control signal φCTL, the reference voltage RAMP, and the count signal to be supplied to the pixel memory 220. Lastly, the readout control circuit 260 reads out data of the SIG conversion result stored in the pixel memory 220 to the image processing/outputting unit 280 by controlling the selection signal φSEL.

In the present embodiment, one pixel circuit 212 is provided for one pixel 112, and all the pixels 112 and the pixel circuits 212 are simultaneously controlled. Accordingly, a so-called global shutter operation is possible in which a plurality of pixels 112 included in the pixel unit 110 are exposed at the same time. In addition, such an operation in which individual pixels 112 are exposed at different times is also possible. Note that, the above-described conversion in the pixel circuit 212 from an analog signal to a digital signal is performed by a so-called single-slope method. However, the conversion may not be limited to this method, and other methods such as a successive approximation register method or the like may be used. The same applies to other embodiments.

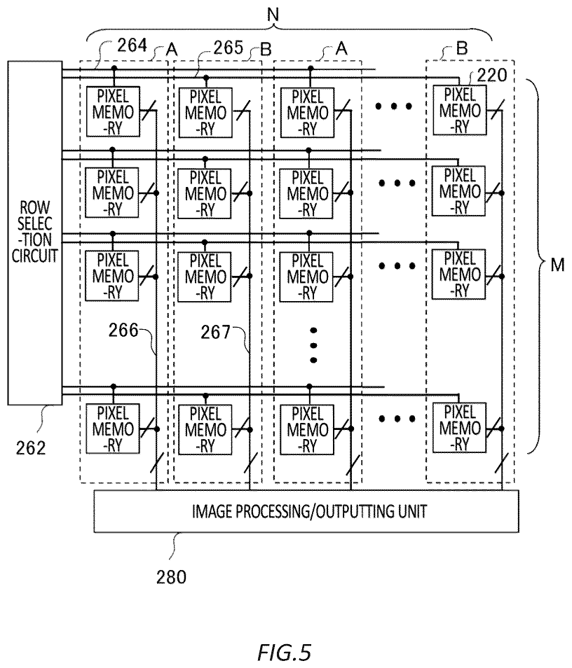

FIG. 5 schematically illustrates a circuit to read out data from the pixel memory 220 to the image processing/outputting unit 280. Components that are not described are omitted in the Figure.

Corresponding to the M×N pixels 121, the M×N pixel memories 220 are disposed. These pixel memories 220 are connected to a row selection line 264, 265 of a row selection circuit 262 in the readout control circuit 260. A row selection signal φSEL is output to the row selection line 264, 265 as an example of the control signal to read out the pixel signal stored in the pixel memory 220. The row selection line 264, 265 may be referred to as a word selection line.

Meanwhile, the pixel memories 220 in included in each column are connected to a common output line 266 to the image processing/outputting unit 280. A pixel signal read out from the pixel memory 220 is output to the output line 266. The output line 266 may be referred to as a bit line.

Here, since the pixel memory 220 stores a digital signal having the number of bits corresponding to gradations or the like of an image signal, the pixel memory 220 includes the number of memory cells according to the number of bits for each pixel 112. For example, if eight bits are used to express the pixel signal of one pixel in 256 levels of gray, then eight memory cells are used. Accordingly, also for outputs from the pixel memory 220, at least the same number of the output lines 266 as the number of bits are used per one column of pixel memories 220, if time division is not applied. In FIG. 5 and thereafter, a diagonal line drawn on a wiring line such as those drawn on the output lines 266 in FIG. 5 indicates that a plurality of wiring lines are represented by one line.

Regarding the readout in the configuration of FIG. 5, performing the readout operations for many pixel memories 220 at one time will increase the amount of current during the readout. Accordingly, the present embodiment suppresses the current during the readout by performing the readout operations for the plurality of pixel memories 220 at different timings. For example, the readout operations for the pixel memories 220 in the even-numbered columns, defined as a memory group A, and the pixel memories 220 in the odd-numbered columns, defined as a memory group B, are performed at different timings. Note that, for convenience of description, the rows and the columns are counted from zero, unless otherwise stated.

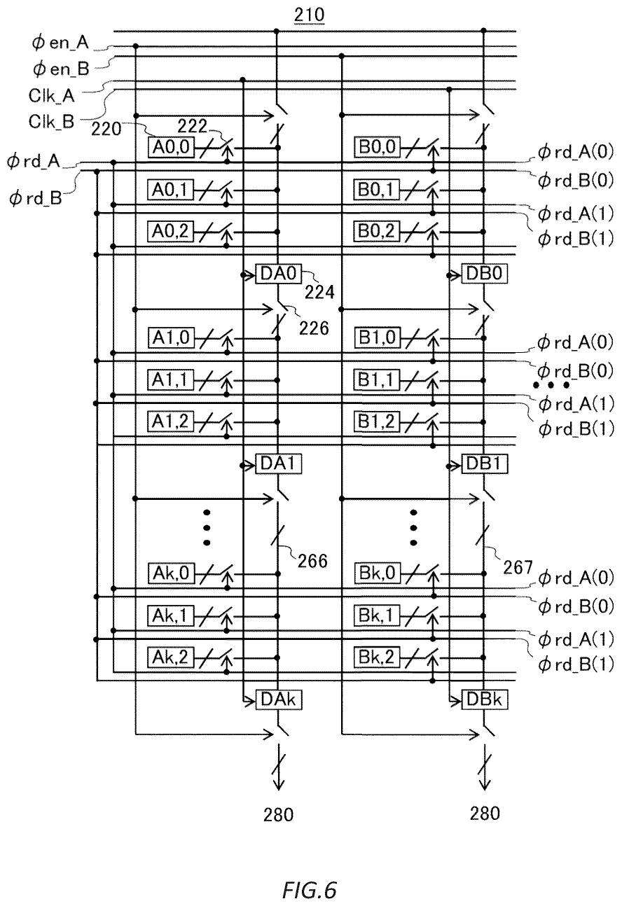

FIG. 6 schematically illustrates, in more detail, a circuit for readout from the pixel memory 220 in the processing circuit unit 210. Components that are not described are omitted in the Figure.

In the example of FIG. 6, each pixel memory 220 is connected to the output line 266, 267 through a switch 222. In addition, a D flip-flop 224 and a switch 226 on the output side of the D flip-flop 224 are provided in the output line 266 per a predetermined number of pixel memories 220. In the example shown in FIG. 6, the D flip-flop 224 and the switch 226 are provided per three pixel memories 220 in the same column. It can be said that they form a memory subgroup per these numbers of pixel memories 220. That is, in the example of FIG. 6, the memory group A can be said to include the memory subgroups AO to Ak.

Similarly, the memory group B includes memory subgroups B0 to Bk. Note that, the pixel memories 220 included in each memory subgroup may be two or less or four or more. In addition, the number of pixel memories 220 included in each memory subgroup may be different from each other. Note that, corresponding to the same number of output lines 266, 267 as the number of bits being provided, the D flip-flops 224 are also provided in the same number as the number of bits, although only one of them is represented in the figure.

In the example of FIG. 6, there are many row selection lines to selectively read out the pixel signals from the pixel memories 220. Hereinafter, in order to avoid complexity, reference numerals of the row selection lines are omitted and signs of the signals are used for the description.

A signal φ_en_A turns on or off the switch 226 in the output line 266 of the memory group A. A signal φ_rd_A(j) (wherein j=0, 1, 2) turns on or off the switch 222 of the pixel memory 220 in the jth row in each of the memory subgroups A0 to Ak. A signal Clk_A is a clock that drives D flip-flops 224 (DA0 to DAk) in the memory group A.

A signal φ_en_B turns on or off the switch 226 in the output line 267 of the memory group B. A signal φ_rd_B(j) (wherein j=0, 1, 2) turns on or off the switch 222 of the pixel memory 220 in the jth row in each of the memory subgroups B0 to Bk. A signal Clk_B is a clock that drives D flip-flops 224 (DB0 to DBk) in the memory group B.

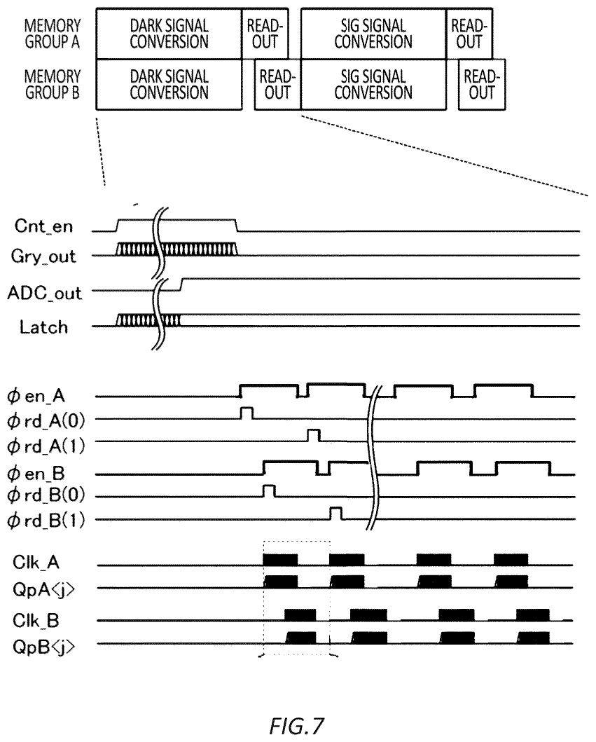

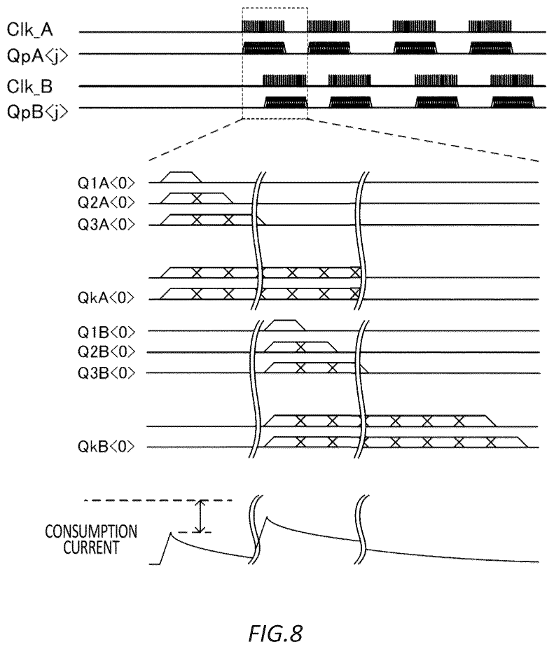

FIG. 7 and FIG. 8 are examples of a timing chart indicating a readout operation from the pixel memory 220 of FIG. 6. Since the timing chart is the same for the DARK signal conversion and readout and the SIG signal conversion and readout, the timing chart of the DARK signal is illustrated and that of the SIG signal is omitted.

An enable signal Cnt_en for A/D conversion is turned on to supply a reference voltage RAMP, and the magnitude of the reference voltage RAMP is counted with a signal Gry_out in association with pulse numbers. The pixel signal and the reference voltage RAMP are compared with each other at the comparator 216, and the pulse number Latch at the time when the output of the comparator 216 becomes high is temporarily stored in the pixel memory. This operation may be performed synchronously for the memory groups A and B at the same timing.

Subsequently, for the memory group A, by turning on the signal φ_rd_A(1) while the signal φ_en_A is in the on-state, a pixel signal of the pixel memory 220 in the first row of each of the memory subgroups Ap (p=0, 1, . . . k) is output to the input side of the corresponding D flip-flop DAp. In this state, by the (k−1) signals Clk_A being input successively, the value of the D flip-flop is sequentially forwarded from p to p+1, and all the pixel signals of the memory subgroup Ap are output to the image processing/outputting unit 280. For the second row and thereafter, the same operation is performed to read out the pixel signals of the memory group A. To add, it can be said that the D flip-flop also functions as a shift register.

On the other hand, while the signal φ_rd_A(j) is turned off and the signals Clk_A are being input for the memory group A, the signal φ_en_B and the signal φ_rd_B(j) are turned on for the memory group B, and thus the pixel signal of the pixel memory 220 in the jth row of each of the memory subgroups Bp is output to the input side of the corresponding D flip-flop DBp. In this state, by the (k−1) signals Clk_B being input successively, the value of the D flip-flop is sequentially forwarded from p to p+1, and all the pixel signals of the memory group B are output to the image processing/outputting unit 280.

This can be said that the readout from the memory group B has started while the readout from the memory group A is in progress. Thus, the outputs QpA<j> and QpB<j> of the D flip-flop are obtained at different timings as shown in FIG. 8, allowing the consumption current during the readout to be suppressed.

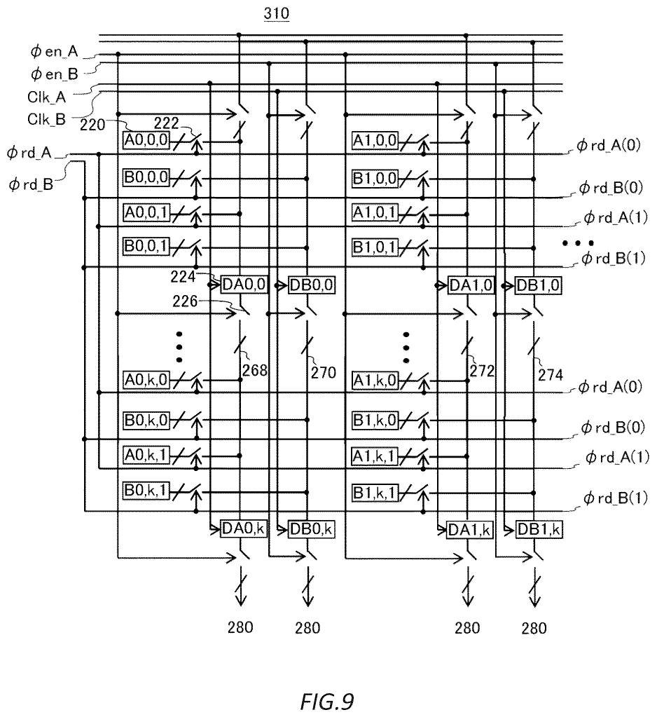

FIG. 9 schematically illustrates, in detail, a circuit for readout from the pixel memory 220 in another processing circuit unit 310. In the processing circuit unit 310, the same components as those of the processing circuit unit 210 in FIG. 6 are provided with like reference numerals and their descriptions are omitted.

In the example of FIG. 9, each of the pixel memories <A0, p, j> (p=0, 1, . . . k: j=0, 1) in the first column is connected to the output line 268 through the switch 222. In addition, the D flip-flop 224 and the switch 226 on the output side of the D flip-flop 224 are provided in the output line 268 per predetermined number of pixel memories (two in the example of FIG. 9).

Similarly, each of the pixel memories <B0, p, j> (p=0, 1, . . . k: j=0, 1) in the same column is connected to the output line 270 through the switch 222. In addition, the D flip-flop 224 and the switch 226 on the output side of the D flip-flop 224 are provided in the output line 270 per predetermined number of pixel memories (two in the example of FIG. 9).

Moreover, each of the pixel memories <A1, p, j> (p=0, 1, . . . k: j=0, 1) in another column is connected to the output line 272 through the switch 222, and D flip-flop 224 and the switch 226 on the output side of the D flip-flop 224 are provided in the output line 268 per predetermined number of pixel memories. Each of the pixel memories <B1, p, j> (p=0, 1, . . . k: j=0, 1) in the same column is connected to the output line 274 through the switch 222, and D flip-flop 224 and the switch 226 on the output side of the D flip-flop 224 are provided in the output line 274 per predetermined number of pixel memories.

A signal line of the signal φ_rd_A(j) is connected in common to the pixel memories <Aq, p, j> (q=0, 1, . . . N−1) in the row direction. Similarly, a signal line of the signal φ_rd_B(j) is connected in common to the pixel memories <Bq, p, j> in the row direction.

From these descriptions, it can be said that the pixel memories in even-numbered rows form a memory group A and the pixel memories in odd-numbered rows form a memory group B. In addition, every two pixel memories in the memory group A in the same column form a memory subgroup Aqp. Similarly, every two pixel memories in the memory group B in the same column form a memory subgroup Bqp.

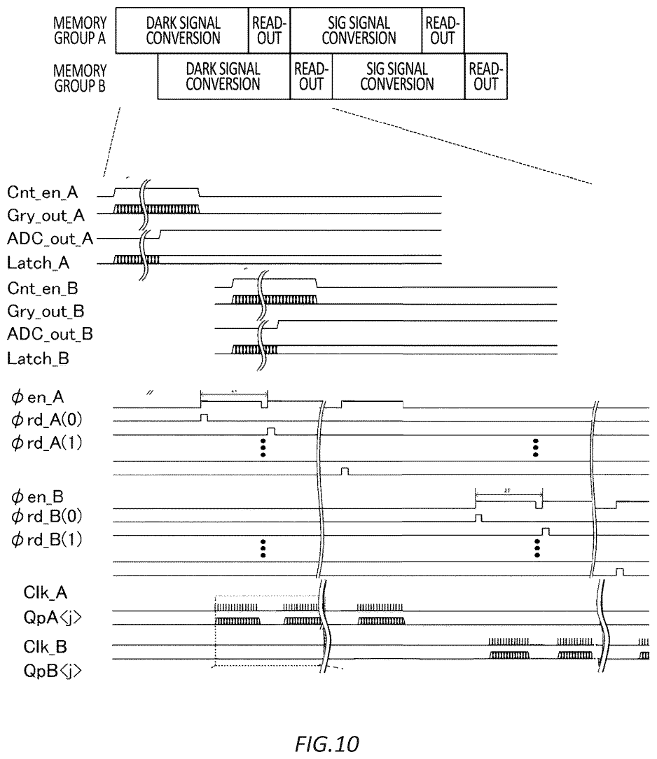

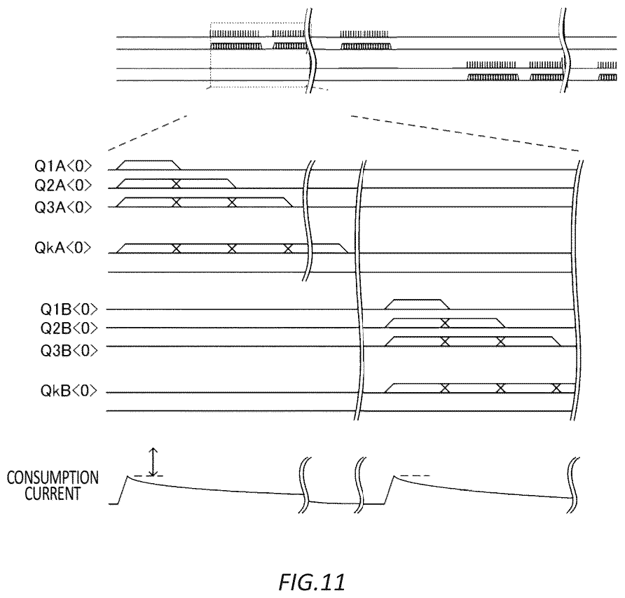

FIG. 10 and FIG. 11 are examples of a timing chart indicating a readout operation from the pixel memory 220 of FIG. 9. Since the timing chart is the same for the DARK signal conversion and readout and the SIG signal conversion and readout, the timing chart of the DARK signal is illustrated and that of the SIG signal is omitted.

For the memory group A, an enable signal Cnt_en_A for A/D conversion is turned on to supply a reference voltage RAMP, and the magnitude of the reference voltage RAMP is counted with a signal Gry_out_A in association with pulse numbers. For the memory group A, the pixel signal and the reference voltage RAMP are compared with each other at the comparator 216, and the pulse number Latch_A at which the output of the comparator 216 becomes high is temporarily stored in the pixel memory.

After the above operation of the memory group A has started, an enable signal Cnt_en_B for A/D conversion is turned on to supply a reference voltage RAMP for the memory group B and the magnitude of the reference voltage RAMP is counted with a signal Gry_out_B in association with pulse numbers. For the memory group B, the pixel signal and the reference voltage RAMP are compared with each other at the comparator 216, and the pulse number Latch_B at which the output of the comparator 216 becomes high is temporarily stored in the pixel memory.

For the memory group A, after the above A/D conversion has been completed, the signal φ_en_A and the signal φ_rd_A(j) are turned on, and thus the pixel signal of the pixel memory 220 in the jth row of each of the memory subgroups Aqp is output to the input side of the corresponding D flip-flop DAqp. In this state, by the (k−1) signals Clk_A being input successively, the value of the D flip-flop is sequentially forwarded from p to p+1, and all the pixel signals of the memory group A are output to the image processing/outputting unit 280.

After all the pixel signals of the memory group A has been output to the image processing/outputting unit 280, the signal φ_en_B and the signal φ_rd_B(j) are turned on for the memory group B, and thus the pixel signal of the pixel memory 220 in the jth row of each of the memory subgroups Bqp is output to the input side of the corresponding D flip-flop DBqp. In this state, by the (k−1) signals Clk_B being input successively, the value of the D flip-flop is sequentially forwarded from p to p+1, and all the pixel signals of the memory group B are output to the image processing/outputting unit 280.

As above, in the processing circuit unit 310, the readout from the memory group B starts after the readout from the memory group A. Accordingly, the outputs QpA<j> and QpB<j> of the D flip-flop are obtained at different timings as shown in FIG. 11, allowing the consumption current during the readout to be suppressed. Note that, the timing of starting the A/D conversion for memory group B may correspond to the timing of starting the readout from the memory group B. For example, the timing of starting the A/D conversion for memory group B may be shifted by a time period from the start to the end of the readout from the memory group A.

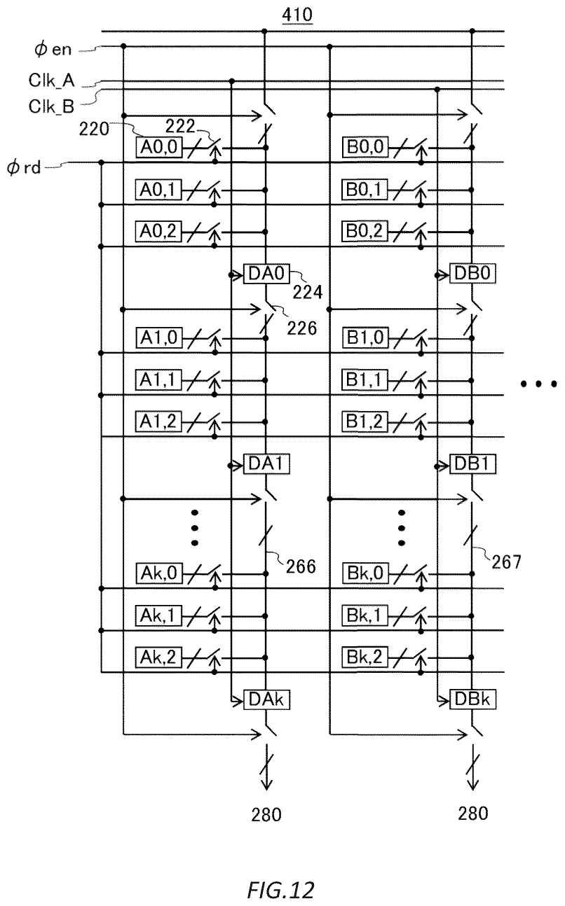

FIG. 12 schematically illustrates, in detail, a circuit for readout from the pixel memory 220 in still another processing circuit unit 410. The processing circuit unit 410 has the same configurations as the processing circuit unit 210 of FIG. 6, except those described in particular.

Again in the processing circuit unit 410, the even-numbered columns form the memory group A and the odd-numbered columns form the memory group B. In addition, every three pixel memories 220 in each of the memory groups A and B form the respective memory subgroups Ap, Bp. However, unlike the processing circuit unit 210, the signal line of the signal φ_rd is connected in common to the memory groups A and B.

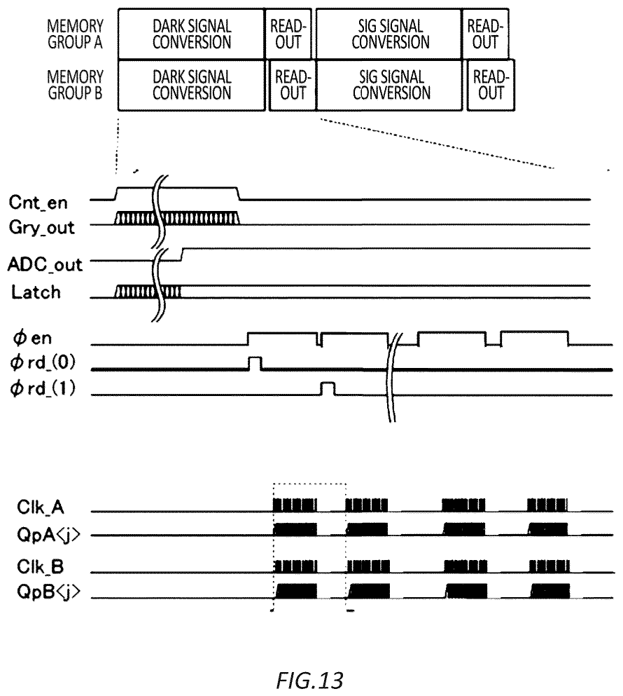

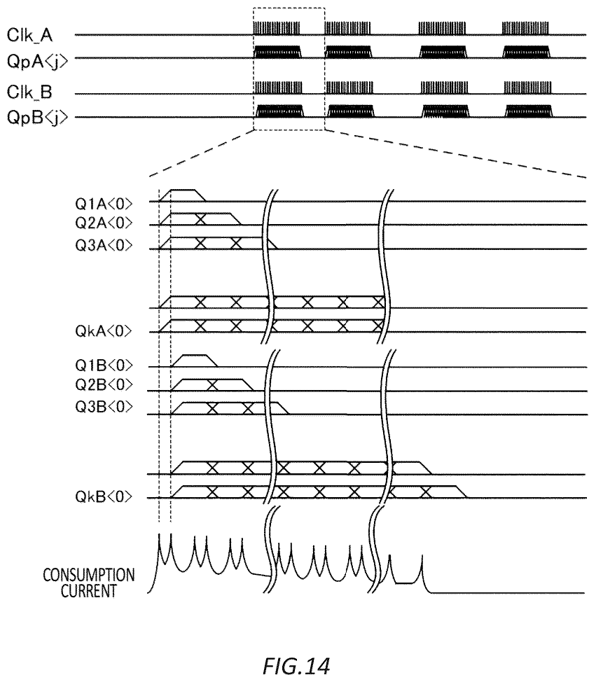

FIG. 13 and FIG. 14 are examples of a timing chart indicating a readout operation from the pixel memory 220 of FIG. 12. Since the timing chart is the same for the DARK signal conversion and readout and the SIG signal conversion and readout, the timing chart of the DARK signal is illustrated and that of the SIG signal is omitted.

The A/D conversion of the DARK signal of FIG. 13 is the same as that of FIG. 7. Subsequently, by the signal φ_en and the signal φ_rd(j) being turned on, the pixel signal is read out from the pixel memory 220 in the jth row of each of the memory subgroups Ap and Bp and is output to the input side of the corresponding one of the D flip-flops DAp, DBp.

In this state, the signal Clk_A is supplied before the signal Clk_B. For example, the phase of the signal Clk_B is delayed from that of the signal Clk_A. Thus, the outputs QpA<j> and QpB<j> of the D flip-flop are obtained at different timings as shown in FIG. 14, allowing the consumption current during the readout to be suppressed. Note that, instead of delaying the phase, the supply of the signal Clk_B may be started a few clocks after the signal Clk_A.

According to the present embodiment, the amount of current that flows during the readout can be made smaller. Note that, in the above-described embodiments, one control circuit 214 is provided for one pixel 112. Alternatively, one control circuit 214 may be provided for a plurality of pixels 112. In this case, supposing that the plurality of pixels 112 corresponding to one control circuit 214 is referred to as a pixel block, the pixel 112 included in one pixel block may be arrayed in m rows and n columns (m is a natural number that is 2 or more and smaller than M, and n is a natural number that is 2 or more and smaller than N), and a plurality of this pixel blocks may be disposed in the row-column direction.

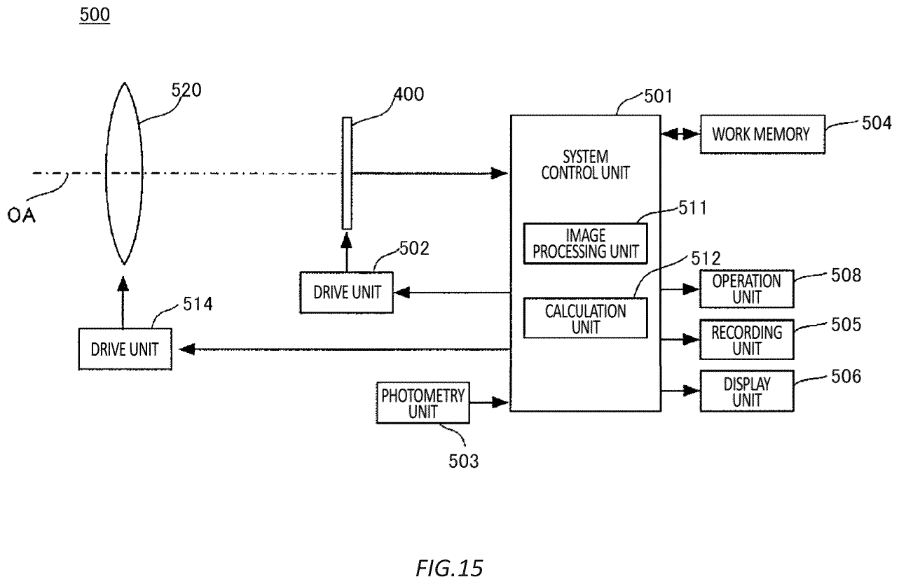

FIG. 15 is a block diagram showing a configuration example of an imaging device 500 according to an embodiment. The imaging device 500 includes the imaging element 400, a system control unit 501, a drive unit 502, a photometry unit 503, a work memory 504, a recording unit 505, a display unit 506, a drive unit 514, and an image taking lens 520.

The image taking lens 520 is configured to guide a subject-emanating light flux incident along an optical axis OA to the imaging element 400. The image taking lens 520 includes a plurality of optical lens groups, and is configured to form an image of the subject-emanating light flux from a scene, in the vicinity of a focal plane of the image taking lens. The image taking lens 520 may be a replaceable lens that can be attached and detached with respect to the imaging device 500. It should be noted that in FIG. 15, the image taking lens 520 is expressed by a single virtual representative lens arranged near the pupil.

The drive unit 514 is configured to drive the image taking lens 520. In an example, the drive unit 514 is configured to move the optical lens group of the image taking lens 520 to change a focusing position. In addition, the drive unit 514 may be configured to drive an iris diaphragm in the image taking lens 520 to control a light amount of the subject-emanating light flux incident on the imaging element 400.

The drive unit 502 has a control circuit configured to execute electric charge accumulating control such as timing control and area control of the imaging element 400 according to instructions from the system control unit 501. In addition, the operation unit 508 is configured to receive an instruction from a photographer using a release button or the like.

The imaging element 400 is configured to transfer pixel signals to an image processing unit 511 of the system control unit 501. The image processing unit 511 is configured to generate image data by performing various image processing using the work memory 504 as a work space. For example, when generating image data of a JPEG file format, compression processing is executed after generating a color video signal from a signal obtained with the Bayer array. The generated image data is recorded in the recording unit 505, converted into a display signal, and displayed on the display unit 506 for a preset time.

The photometry unit 503 is configured to detect a luminance distribution of a scene prior to a series of image taking sequences for generating image data. The photometry unit 503 includes, for example, an AE sensor with approximately one million pixels. A calculation unit 512 of the system control unit 501 is configured to receive an output of the photometry unit 503 and to calculate a luminance for each area of the scene.

The calculation unit 512 is configured to determine a shutter speed, an aperture value, and an ISO sensitivity according to the calculated luminance distribution. The photometry unit 503 may also be used by the imaging element 400. Note that, the calculation unit 512 is also configured to execute various calculations for operating the imaging device 500. The drive unit 502 may be partially or entirely mounted on the imaging element 400. A part of the system control unit 501 may be mounted on the imaging element 400.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the described scope of the claims that the embodiments added with such alterations or improvements can be included the technical scope of the present invention.

The operations, procedures, steps, stages, or the like of each process performed by a device, system, program, and method shown in the claims, specification, or drawings can be performed in any order as long as the order is not indicated by “prior to,” “before,” or the like and as long as the output from a previous process is not used in a later process. Even if the operation flow is described using phrases such as “first” or “then” in the claims, specification, or drawings, it does not necessarily mean that the process must be performed in this order.

What is claimed is:

1. An imaging element, comprising:
a first substrate that includes a pixel unit in which a plurality of pixels are arranged in line in a row direction, each of the plurality of pixels includes at least a photoelectric conversion unit which converts light into an electric charge; and
a second substrate that includes a processing circuit unit in which a first pixel circuit including at least a first pixel memory that stores a first pixel signal from a first pixel in the plurality of pixels and a second pixel circuit including at least a second pixel memory that stores a second pixel signal from a second pixel in the plurality of pixels are arranged, and a readout control circuit to read out each of the first pixel signal stored in the first pixel memory and the second pixel signal stored in the second pixel memory at different timings from each other.

2. The imaging element according to claim 1, wherein
the second pixel is arranged next to the first pixel in line in the row direction.

3. The imaging element according to claim 1 or 2, wherein
the second pixel circuit is arranged next to the first pixel circuit in line in the row direction.

4. The imaging element according to any one of claims 1 to 3, comprising:
a first selection line to which a first control signal to read out the first pixel signal stored in the first pixel memory is output; and
a second selection line to which a second control signal to read out the second pixel signal stored in the second pixel memory is output, wherein
the readout control circuit performs control so that a timing of outputting the first control signal to the first selection line and a timing of outputting the second control signal to the second selection line are different from each other.

5. The imaging element according to claim 4, wherein
the readout control circuit performs control so that a timing of starting output of the first control signal and a timing of starting output of the second control signal are different from each other.

6. The imaging element according to claim 5, wherein
the readout control circuit starts output of the second control signal after starting output of the first control signal.

7. The imaging element according to claim 6, wherein
the readout control circuit starts output of the second control signal after finishing output of the first control signal.

8. The imaging element according to any one of claims 1 to 7, comprising:
a first output line to which the first pixel signal read out from the first pixel memory is output; and
a second output line to which the second pixel signal read out from the second pixel memory is output, wherein
the readout control circuit performs control so that a timing of reading out the first pixel signal from the first pixel memory to the first output line and a timing of reading out the second pixel signal from the second pixel memory to the second output line are different from each other.

9. The imaging element according to claim 8, wherein
the readout control circuit performs control so that a timing of starting readout of the first pixel signal and a timing of starting readout of the second pixel signal are different from each other.

10. The imaging element according to claim 9, wherein
the readout control circuit starts readout of the second pixel signal after starting readout of the first pixel signal.

11. The imaging element according to claim 10, wherein
the readout control circuit starts readout of the second pixel signal after finishing readout of the first pixel signal.

12. The imaging element according to any one of claims 1 to 11, wherein
the first pixel circuit includes a first comparator that is used to convert the first pixel signal from the first pixel into a digital signal,
the second pixel circuit includes a second comparator that is used to convert the second pixel signal from the second pixel into a digital signal,
the first pixel memory stores the first pixel signal converted into the digital signal using the first comparator, and
the second pixel memory stores the second pixel signal converted into the digital signal using the second comparator.

13. The imaging element according to any one of claims 1 to 12, wherein
each of the first pixel memory and the second pixel memory is constituted by SRAM.

14. The imaging element according to any one of claims 1 to 13, wherein
the first substrate and the second substrate are arranged so that at least part of the pixel unit and at least part of the processing circuit unit face each other.

15. The imaging element according to claim 14, wherein
the first substrate and the second substrate are arranged so that at least part of the first pixel and at least part of the first pixel circuit face each other.

16. The imaging element according to claim 14 or 15, wherein
the first substrate and the second substrate are arranged so at least part of the second pixel and at least part of the second pixel circuit face each other.

17. The imaging element according to any one of claims 1 to 16, wherein
the second substrate includes a pixel control circuit that controls each of the first pixel and the second pixel.

18. The imaging element according to claim 17, wherein
the pixel control circuit controls an exposure time of the first pixel and an exposure time of the second pixel.

19. The imaging element according to claim 17 or 18, wherein
the pixel control circuit controls readout of the first pixel signal from the first pixel and readout of the second pixel signal from the second pixel.

20. The imaging element according to any one of claims 17 to 19, wherein
the processing circuit unit is arranged between the readout control circuit and the pixel control circuit in the row direction.

21. The imaging element according to any one of claims 1 to 20, wherein
the second substrate includes an image processing unit that performs image processing on the first pixel signal stored in the first pixel memory and the second pixel signal stored in the second pixel memory.

22. The imaging element according to any one of claims 1 to 20, comprising
a third substrate that includes an image processing unit that performs image processing on the first pixel signal stored in the first pixel memory and the second pixel signal stored in the second pixel memory.

23. An imaging device comprising the imaging element according to any one of claims 1 to 22.

24. The imaging device according to claim 23, comprising
a control unit that is connected to the imaging element.

25. The imaging device according to claim 24, wherein
the control unit generates image data based on the first pixel signal and the second pixel signal.
